(19) United States
(12) Patent Application Publication
(10) Pub. No.: US 2026/0044810 A1
(43) Pub. Date: Feb. 12, 2026

(54) TERMINAL, MANAGEMENT SYSTEM, AND MANAGEMENT METHOD

(71) Applicant: MITSUI E&S CO., LTD., CHUO-KU, TOKYO (JP)

(72) Inventor: Yoshiki SAKAGUCHI, CHUO-KU, TOKYO (JP)

(21) Appl. No.: 19/100,729

(22) PCT Filed: Aug. 2, 2023
(86) PCT No.: PCT/JP2023/028235

§ 371 Date: Feb. 3, 2025

(30) Foreign Application Priority Data
Aug. 3, 2022 (JP) 2022-124112

(51) Int. Cl. G06Q 10/0832; B65G 63/00

(52) U.S. Cl. CPC G06Q 10/0832; B65G 63/002

(57) ABSTRACT

Provided is a terminal, a management system, and a management method which can suppress a decrease in cargo handling efficiency. Upon satisfying a constraint condition that cargo handling efficiency from initiation to termination of cargo handling operations indicated by a large number of pieces of cargo handling operation data does not fall below a reference, data processing of creating an operation schedule for each of a plurality of cargo handling apparatuses incorporating a plurality of cargo handling operation times during which cargo handling operations indicated by the allocated plurality of pieces of cargo handling operation data are executed and spare times during which no cargo handling operation is executed, and a supply operation for supplying a hydrogen gas from a supplying apparatus to the cargo handling apparatus is set in at least one of a plurality of the spare times.

### TECHNICAL FIELD

The present invention relates to a terminal including cargo handling apparatuses which use a hydrogen gas as a fuel, and a management system and a management method which manages the cargo handling apparatuses, and specifically relates to a terminal, a management system, and a management method which can suppress a decrease in cargo handling efficiency.

### BACKGROUND ART

Various container terminals which suppress the amount of carbon dioxide to be discharged have been proposed (see, for example, Patent Document 1). Patent Document 1 discloses a configuration of a gantry crane which operates upon supply of electricity from a trolley wire laid on a container terminal. By electrifying cargo handling apparatuses such as gantry cranes, the amount of carbon dioxide to be discharged in a container terminal can be suppressed.

When trolley wires are laid on an existing container terminal, there has been a problem that cargo handling operations cannot be conducted over a long period of time. On the other hand, it has been studied to suppress the amount of carbon dioxide to be discharged by changing the fuel of gantry cranes to a hydrogen gas.

Since a hydrogen gas has a lower calorie relative to the volume than light oil, there is a possibility that a gantry crane runs out of the fuel during a cargo handling operation. In addition, the frequency of fuel supply operations to gantry cranes becomes higher for a hydrogen gas than for light oil. If the fuel of gantry cranes is changed to a hydrogen gas, there is a possibility that the cargo handling efficiency in a container terminal decreases.

### PRIOR ART DOCUMENT

### Patent Document

Patent Document 1: Japanese patent application Kokai publication No. 2003-137494

### SUMMARY OF THE INVENTION

### Problem to be Solved by the Invention

The present invention has been made in view of the above-described problems, and an object of the present invention is to provide a terminal, a management system, and a management method which can suppress a decrease in cargo handling efficiency.

### Means for Solving the Problem

A terminal for achieving the above-described object is a terminal comprising: a plurality of cargo handling apparatuses which use a hydrogen gas as a fuel; a supplying apparatus which supplies the hydrogen gas to the cargo handling apparatuses; and a management system which allocates a plurality of pieces of cargo handling operation data among a large number of pieces of cargo handling operation data to each of the cargo handling apparatuses, characterized in that upon satisfying a constraint condition that cargo handling efficiency from initiation to termination of cargo handling operations indicated by the large number of pieces of cargo handling operation data does not fall below a reference, the management system executes data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and the management system has a configuration of setting a supply operation for supplying the hydrogen gas from the supplying apparatus to the cargo handling apparatus in at least one of a plurality of the spare times.

A management system for achieving the above-described object is a management system which allocates a plurality of pieces of cargo handling operation data among a large number of pieces of cargo handling operation data to each of a plurality of cargo handling apparatuses which use a hydrogen gas as a fuel, characterized in that upon satisfying a constraint condition that cargo handling efficiency from initiation to termination of cargo handling operations indicated by the large number of pieces of cargo handling operation data does not fall below a reference, the management system executes data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and the management system has a configuration of setting a supply operation for supplying the hydrogen gas from the supplying apparatus to the cargo handling apparatus in at least one of a plurality of the spare times.

A management method for achieving the above-described object is a management method which allocates a plurality of pieces of cargo handling operation data among a large number of pieces of cargo handling operation data to each of a plurality of cargo handling apparatuses which use a hydrogen gas as a fuel, characterized in that the management method comprises upon satisfying a constraint condition that cargo handling efficiency from initiation to termination of cargo handling operations indicated by the large number of pieces of cargo handling operation data does not fall below a reference, executing data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and the management method has a configuration of setting a supply operation for supplying the hydrogen gas from a supplying apparatus to the cargo handling apparatus in at least one of a plurality of the spare times.

### Effects of the Invention

According to the present invention, the supply operation for supplying the fuel can be conducted during a spare time during which the cargo handling apparatus is not conducting a cargo handling operation. Since the timing to conduct the supply operation is determined in advance, the preparation of the supply operation can be conducted in advance. This is advantageous in suppressing a decrease in cargo handling efficiency.

### BRIEF DESCRIPTION OF THE DRAWINGS

FIG. 1 is an explanatory diagram illustrating an overview of a terminal.

FIG. 2 is an explanatory diagram illustrating a configuration of a management system.

FIG. 3 is an explanatory diagram illustrating a flow of data processing in the management system.

FIG. 4 is an explanatory diagram illustrating a large number of pieces of cargo handling operation data.

FIG. 5 is an explanatory diagram illustrating an operation schedule of a gantry crane.

FIG. 6 is an explanatory diagram illustrating a modification of the flow of FIG. 3.

FIG. 7 is an explanatory diagram illustrating a situation in which a container is handled by a gantry crane.

FIG. 8 is an explanatory diagram illustrating data processed in an estimating step.

FIG. 9 is an explanatory diagram illustrating an operation schedule of a gantry crane.

FIG. 10 is an explanatory diagram illustrating an operation schedule of a gantry crane different from FIG. 9.

FIG. 11 is an explanatory diagram illustrating an overview of a mobile supplying apparatus.

FIG. 12 is an explanatory diagram illustrating an operation schedule of the mobile supplying apparatus.

FIG. 13 is an explanatory diagram illustrating an operation schedule of a yard chassis.

### MODES FOR CARRYING OUT THE INVENTION

Hereinafter, a terminal, a management system, and a management method will be described based on embodiments shown in the drawings.

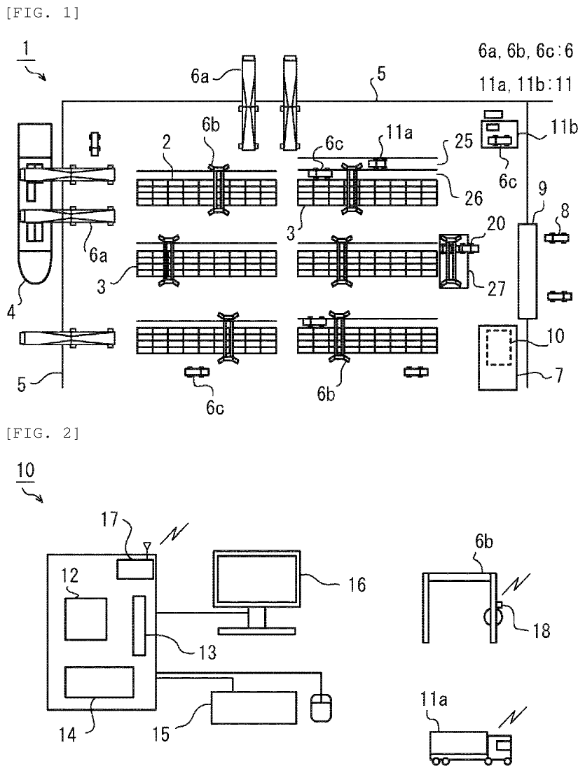

As illustrated in FIG. 1, a terminal 1 includes a plurality of storage lanes 3 in which containers 2 are stored, and a quay 5 at which a container ship 4 berths. The containers 2 are handled by cargo handling apparatuses 6. The cargo handling apparatuses 6 include, for example, quay cranes 6a which are disposed on the quay 5, gantry cranes 6b which travel along the storage lanes 3, and yard chassis 6c which travel in the terminal 1. In the present Description, the cargo handling apparatuses 6 are not limited to the above, and only have to be apparatuses used for cargo handling, and are a concept encompassing straddle carriers, forklifts, top lifters, and reach stackers, for example. The cargo handling apparatus 6 may be a manned cargo handling apparatus 6 which is directly or remotely operated by an operator, or may be an unmanned cargo handling apparatus 6 which is controlled by automatic control.

Each of the plurality of cargo handling apparatuses 6 has a configuration of operating by using a hydrogen gas as a fuel. The cargo handling apparatus 6 includes, for example, a fuel cell, a mechanism combining, for example, a hydrogen engine and a power generator, and the like. In the terminal 1, the configuration is not limited to the case where all the cargo handling apparatuses 6 use a hydrogen gas as a fuel. A configuration may be employed in which some of the cargo handling apparatuses 6 operate by using electricity supplied from a power feed cable, while the other cargo handling apparatuses 6 operate by using a hydrogen gas as the fuel.

The terminal 1 includes a management building 7 and a gate 9 where entrance and exit of an external chassis 8 are managed. In the management building 7, a management system 10 which manages operation schedules of the cargo handling apparatuses 6 is installed. In FIG. 1, the management system 10 is indicated by a dashed line for explanation.

The terminal 1 includes a plurality of supplying apparatuses 11 which supply the hydrogen gas to the cargo handling apparatuses 6. The supplying apparatus 11 is configured with a mobile supplying apparatus 11a which includes a vehicle on which hydrogen tanks are mounted, for example. The mobile supplying apparatus 11a can move to near the cargo handling apparatus 6 and supply the hydrogen gas to the cargo handling apparatus 6. The supplying apparatus 11 may be configured with a stationary supplying apparatus 11b which includes a dispenser and hydrogen tanks fixed to the ground, for example. The stationary supplying apparatus 11b can supply the hydrogen gas to the cargo handling apparatus 6 which has moved thereto.

The terminal 1 of the present invention is not limited to a container terminal. The terminal 1 includes a quay for product shipping of ironworks or the like and a quay for bulk cargos of coal or the like.

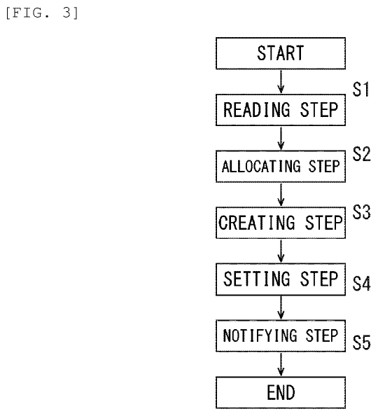

As illustrated in FIG. 2, the management system 10 may be configured with various known computers. The management system 10 includes a central processing unit (CPU) 12, a main storage unit (a memory) 13, an auxiliary storage unit (for example, a HDD) 14, input units (a keyboard 15, a mouse), and output units (a display 16, a printer). A conventional management system can be used as the management system 10 of the present invention by adding functions to the management system or changing programs.

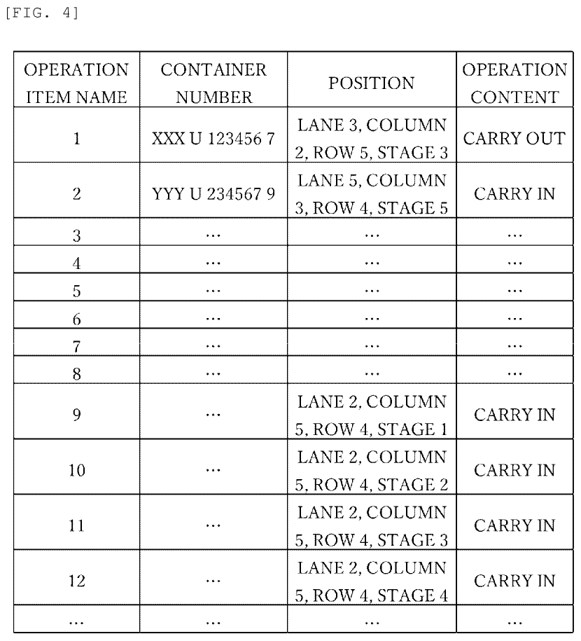

The processing conducted by the management system 10 will be described with reference to a flow illustrated in FIG. 3. Hereinafter, a case where the cargo handling apparatuses 6 are the gantry cranes 6b will be described as an example. Once the management system 10 starts the processing (START), first in a reading step S1, a large number of pieces of cargo handling operation data are read. Specifically, cargo handling operation data is read from the auxiliary storage unit 14 into the main storage unit 13. The cargo handling operation data may be created by the management system 10 based on scheduled arrival and departure dates and times of transport apparatuses such as the container ship 4 or the external chassis 8 or the number of shipments to be loaded into or unloaded from a storage facility such as the storage lane 3. In this case, in the reading step S1, the scheduled arrival and departure dates and times of transport apparatuses and the like is read from the auxiliary storage unit 14 into the main storage unit 13, and the main storage unit 13 and the central processing unit 12 create the cargo handling operation data.

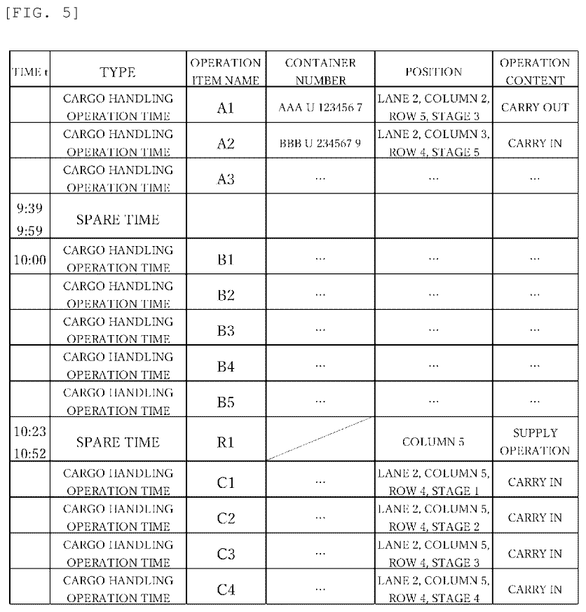

As illustrated in FIG. 4, the cargo handling operation data contains the container numbers of containers 2 to be handled, the positions of the containers 2 in the storage lanes 3, operation contents, and the like. In addition, operation item names may be contained in the cargo handling operation data such as 1, 2, and the like.

For example, in the operation item name 1, the operation of carrying the container 2 of XXX U 123456 7 on lane 3, column 2, row 5, stage 3 out to the external chassis 8 is conducted by the gantry crane 6b. In the operation item name 2, the operation of carrying the container 2 of YYY U 234567 9 from the external chassis 8 into lane 5, column 3, row 4, stage 5 is conducted by the gantry crane 6b. Note that the positions of the containers 2 are specified by defining the position in the traveling direction of the gantry crane 6b as column, the position in a transverse direction which transverses the traveling direction at right angles as row, and the position in a vertical direction as stage.

In an allocating step S2, a large number of pieces of cargo handling operation data are allocated to each cargo handling apparatus 6. For example, the cargo handling operation data of operation item name 1 is allocated to the gantry crane 6b which conducts cargo handling operation on lane 3, and the cargo handling operation of operation item name 2 is allocated to the gantry crane 6b which conducts cargo handling operation on lane 5. In the case where the cargo handling apparatuses 6 are configured with the yard chassis 6c as well, a plurality of pieces of cargo handling operation data are allocated to each yard chassis 6c in the same manner.

In a creating step S3, an operation schedule is created for each cargo handling apparatus 6. Upon satisfying a constraint condition that cargo handling efficiency from initiation to termination of cargo handling operations indicated by the large number of pieces of cargo handling operation data does not fall below a reference, the management system 10 executes data processing of creating an operation schedule for each of the plurality of cargo handling apparatuses 6, the operation schedule incorporating a plurality of cargo handling operation times during which the cargo handling operations indicated by the plurality of pieces of cargo handling operation data are executed and a spare time during which no cargo handling operation is executed between the cargo handling operation times. As the method for creating an operation schedule in the creating step S3, an existing method may be used. In this case, the method is different from the conventional method in that an operation schedule incorporating not only cargo handling operation times but also a spare time is created.

The reference for the cargo handling efficiency can be set as desired. This reference only has to be such that an operation schedule which obviously lowers the cargo handling efficiency can be eliminated. The constraint condition may be set such that the number of shipments which can be processed in the terminal 1 increases, or may be set such that the termination time of a large number of cargo handling operations should not be delayed as much as possible, or may be set such that the degree of influence on a decrease in cargo handling efficiency becomes small. In a mathematical programming problem (optimization problem), the constraint condition is a condition which a solution satisfies, and can limit computation conducted by the management system 10.

The cargo handling efficiency can be evaluated in accordance with the number of shipments such as the container 2 which can be handled per unit time or the amount of the fuel to be consumed per unit time.

The operation schedule can be created through prediction models of machine learning or mathematical optimization. The operation schedule may be created by predicting a consumption amount of the fuel to be consumed for each of a large number of pieces of cargo handling operation data, and setting a plurality of cargo handling operation times and spare times by using prediction models generated by machine learning from scheduled execution times of a large number of cargo handling operations and the consumption amounts of the fuel thus predicted. Alternatively, the operation schedule may be created by setting a plurality of cargo handling operation times and spare times by using prediction model generated by machine learning using a large number of accumulated operation schedules as learning data and a large number of pieces of cargo handling operation data. Alternatively, the operation schedule may be created by setting a plurality of cargo handling operation times and spare times by using a large number of pieces of cargo handling operation data and an optimization algorithm. As the learning data, a large number of accumulated operation schedules are used. The machine learning only has to be conditional. Since this is also an optimization problem, the steepest descent method, the genetic algorithm, the Bayes' optimization, or the like may be used in place of prediction models.

In a setting step S4, at least one is selected from among a plurality of spare times set in the operation schedule, and a supply operation for supplying the hydrogen gas from the supplying apparatus 11 to the cargo handling apparatus 6 during this spare time is set. The creating step S3 and the setting step S4 may be executed simultaneously such that the supply operation is set simultaneously along the setting of the cargo handling operation times and the spare times.

In a notifying step S5, each of the cargo handling apparatuses 6 and the supplying apparatus 11 is notified of the created operation schedule. As illustrated in FIG. 2, the management system 10 may include a communication device 17 such that each of the cargo handling apparatuses 6 and the supplying apparatus 11 is notified of the operation schedule through this communication device 17. Each of the cargo handling apparatuses 6 and the supplying apparatus 11 includes a device such as a communication device for receiving the operation schedule from the management system 10.

As illustrated in FIG. 5, in the operation schedule created by the management system 10, spare times are set in addition to cargo handling operation times. This operation schedule is for the gantry crane 6b which conducts the cargo handling operation on lane 2. In the embodiment illustrated in FIG. 5, a supply operation R1 is set in one of the spare times. In the cargo handling operation data corresponding to the supply operation R1, a position at which the supply operation is conducted such as column 5, for example, may be designated.

In the case where the gantry crane 6b is a manned crane, the operation schedule is displayed on a monitor of the gantry crane 6b. The operator conducts the cargo handling operations while checking the operation schedule. The cargo handling operations are conducted, for example, from the top to the bottom of the operation schedule in this order.

A spare time during which no cargo handling operation is conducted is incorporated in an operation schedule which satisfies the constraint condition that the cargo handling efficiency does not fall below the reference. By utilizing this spare time, the supply operation for supplying the hydrogen gas to the cargo handling apparatus 6 can be conducted. It becomes possible to replenish the fuel to be consumed in the next cargo handling operation time by utilizing the spare time provided between the plurality of cargo handling operation times but not replenish the fuel which ran short during execution of the cargo handling operations shown by a large number of pieces of cargo handling operation data. In addition, since the timing to conduct the supply operation is determined in advance, the preparation of the supply operation can be conducted in advance. This is advantageous in suppressing a decrease in cargo handling efficiency attributable to replenishment of the fuel.

In the cargo handling operations of the gantry crane 6b, there are a series of continuous operations. There is a case where a plurality of containers 2 are continuously carried from the container ship 4 illustrated in FIG. 1 into a certain storage lane 3, or from a certain storage lane 3 into the container ship 4. Such cargo handling conducted between the container ship 4 and the terminal 1 is referred to as ship cargo handling below in some cases. The shorter the mooring time of the container ship 4 is, the larger the number of shipments which can be processed in the terminal 1 is, thus improving the cargo handling efficiency. Hence, it is desirable that ship cargo handling be conducted in a concentrated manner in a short period of time.

In order to efficiently conduct ship cargo handling, there is a case of rearranging a plurality of containers 2 stored in the storage lanes 3. The position of a container 2 is changed in a single storage lane 3, or the position of a container 2 is changed from a certain storage lane 3 to another storage lane 3. Such cargo handling conducted in the storage lanes 3 is referred to as rearrangement cargo handling below in some cases.

There is a case where a container 2 is carried in a storage lane 3 from the outside of the terminal 1 by an external chassis 8, or a container 2 in a storage lane 3 is carried out of the terminal 1 by an external chassis 8. Such cargo handling conducted between the storage lanes 3 and the external chassis 8 is referred to as external cargo handling below in some cases.

A series of continuous cargo handling operations such as ship cargo handling, rearrangement cargo handling, or external cargo handling may be collectively set as a data group. In FIG. 5, an alphabet different for each data group is added to the operation item name. For example, A1-3 are external cargo handling, B1-5 are rearrangement cargo handling, and C1-4 are ship cargo handling.

The data group is configured by combining a plurality of pieces of cargo handling operation data which are adjacent to each other when the plurality of pieces of cargo handling operation data allocated to a target cargo handling apparatus 6 are arranged in time series. The data group is set in the creating step S3 based on cargo handling operation data. For example, in the case where pieces of cargo handling operation data for which the column of a gantry crane 6b almost does not change continues, the management system 10 combines these pieces of cargo handling operation data as the same data group. The data group may be set in the allocating step S2 in which a large number of pieces of cargo handling operation data are allocated to each cargo handling apparatus 6, for example.

The data group may be set in the reading step S1, for example. For example, when a plurality of pieces of cargo handling operation data are set as ship cargo handling, the plurality of pieces of cargo handling operation data are associated with each other as the same data group in advance.

The method for displaying cargo handling operation data and data groups and information contained therein, which are illustrated in FIG. 5, are one example, and the present invention is not limited to this. The method for displaying cargo handling operation data and the like can be changed as appropriate, and information contained in cargo handling operation data and the like can be added as appropriate.

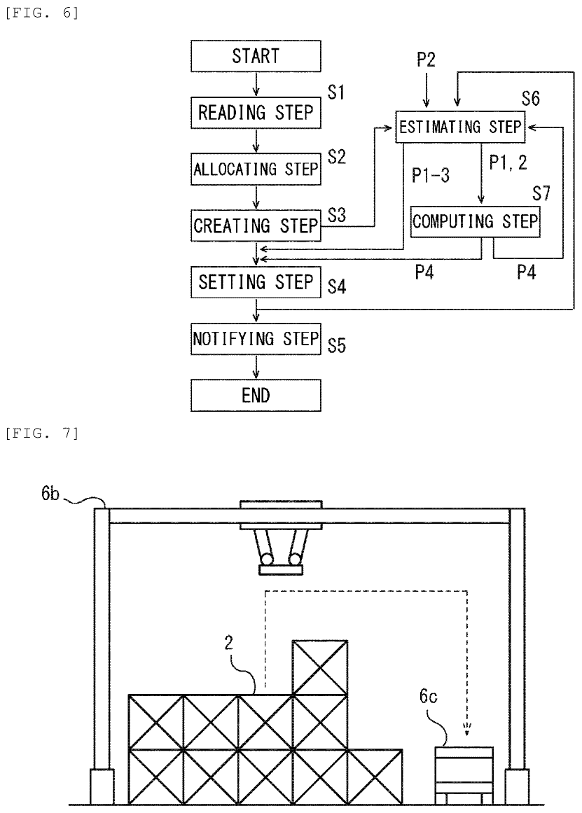

As illustrated in FIG. 6, the management system 10 may include an estimating step S6 of estimating a necessary amount P1, which is the amount of the hydrogen gas necessary for the cargo handling apparatus 6 in the cargo handling operation, based on cargo handling operation data of the operation schedule. In the estimating step S6, the necessary amount P1 [kg] which is the amount of the hydrogen gas to be consumed in the cargo handling operation for each piece of cargo handling operation data of the operation schedule created in the creating step S3 is estimated. The necessary amount P1 is estimated as the weight of the hydrogen gas, for example. In the estimating step S6, the necessary amount P1 can be estimated from the workload of a cargo handling apparatus 6, for example. The estimating step S6 is not an essential configuration requirement.

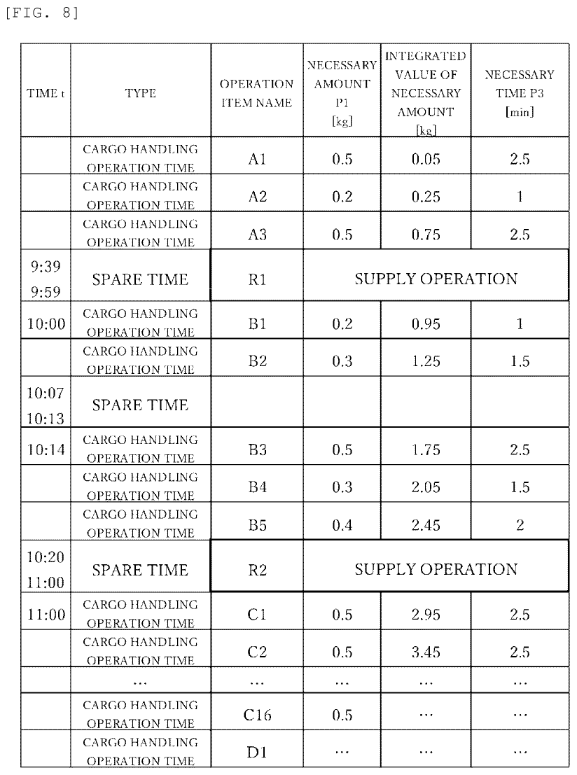

As illustrated in FIG. 7, the gantry crane 6b which has stopped in a certain column carries the container 2 on line 3, stage 2 out to the yard chassis 6c. In FIG. 7, the movement path of the container 2 is indicated by a dashed line for explanation. Once the position of the container 2 to be handled is determined, the workload of the gantry crane 6b can be determined from the height at which this container 2 is hung, and the distance by which the container 2 moves in the row direction (the left-right direction in FIG. 7). From this workload, the necessary amount P1 is estimated in the estimating step S6. In the case where the gantry crane 6b travels in a column direction (in a direction from the front side to the deep side in FIG. 7), the workload is determined from the own weight and the travel distance of the gantry crane 6b, and the necessary amount P1 is estimated from this workload in the estimating step S6 as in the case of the above. The larger the distance by which the container 2 or the gantry crane 6b is moved is, the larger the workload is, so that the consumption amount of the hydrogen gas increases.

A configuration may be employed in which the estimating step S6 determines a workload considering the weight of the container 2 to be handled, and estimates the necessary amount P1 from this workload. In a conventional management system as well, there is a case where the weight including the content of the container 2 is recorded for each container number. The management system 10 can acquire the weight of the container 2 from cargo handling operation data, for example. For example, the necessary amount P1 varies between an empty container of 4 t and a container of 25 t filled with shipments nearly up to the specification. This is advantageous in improving the accuracy of estimation of the necessary amount P1 in the estimating step S6. Note that in the case where the weight is not considered in the estimating step S6, a configuration may be employed in which the weight of the container 2 is determined in advance such as 15 t, for example, and the estimating step S6 determines the workload.

As illustrated in FIG. 2, the cargo handling apparatus 6 includes a remaining amount sensor 18 which measures a remaining amount P2 of the hydrogen gas in the hydrogen tank mounted thereon. The management system 10 can acquire the remaining amount P2 from this remaining amount sensor 18 through the communication device 17. A configuration may be employed in which the management system 10 acquires the remaining amount P2 in the estimating step S6. The remaining amount sensor 18 is configured with, for example, a pressure sensor which measures the pressure inside the hydrogen tank or a weight sensor which measures the weight of the hydrogen tank and the hydrogen gas therein.

The estimating step S6 may have a configuration of estimating a necessary time P3 [min] which is necessary for the operation for each piece of cargo handling operation data. In the estimating step S6, the travel distance of a gantry crane 6b or the movement distance of a container 2 is determined from the content of cargo handling operation data, and a necessary time P3 which is necessary for the operations is estimated. Next, on the assumption that the hydrogen gas is consumed in proportion to the necessary time P3, the necessary amount P1 may be estimated in the estimating step S6.

In the embodiment illustrated in FIG. 6, the management system 10 sets a supply operation R in an operation schedule based on values of the necessary amount P1 and the remaining amount P2 in the setting step S4. In this embodiment, after setting cargo handling operation times and a spare time in the creating step S3, the management system 10 sets a supply operation in the setting step S4.

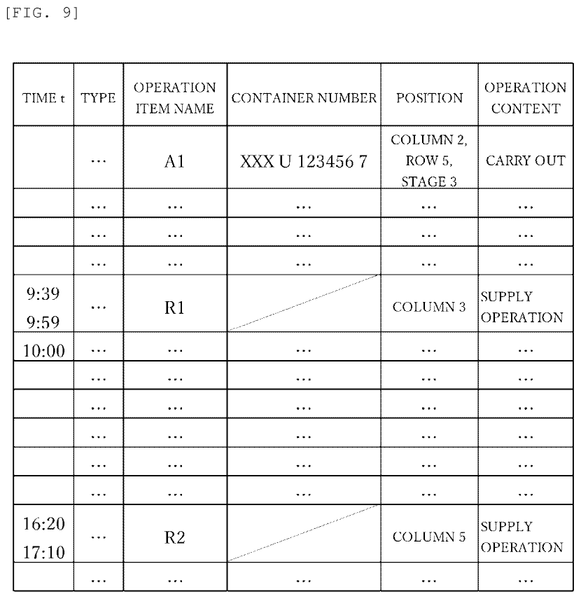

As illustrated in FIG. 8, in the estimating step S6, the necessary amount P1 of the hydrogen gas is estimated for each piece of cargo handling operation data. In addition, the amount of the hydrogen gas which is required until certain cargo handling operation data can be estimated by integrating this necessary amount P1. In the case where the value of the remaining amount P2 acquired by the management system 10 from the remaining amount sensor 18 of the gantry crane 6b is, for example, 3.2 kg, the integrated value of the necessary amount P1 becomes 3.45 kg in operation item name C2 and exceeds the remaining amount P2. In the setting step S4, the supply operation R is inserted into a position before the necessary amount P1 exceeds the remaining amount P2, that is, the spare time set at time t before C2. For example, the supply operation R is set in the spare time between A3 and B1, or between B2 and B3, or between B5 and C1, of operation item names. The supply operation R may be set in each of a plurality of spare times. As long as the integrated value of the necessary amount P1 does not exceed the remaining amount P2, the supply operation R may be set in any spare time in the operation schedule.

The table illustrated in FIG. 8 is not managed as an operation schedule. However, the table may be changed to a state where the necessary amount P1 and the necessary time P3 are displayed in the operation schedule as necessary. The operation schedules in which the supply operations R are inserted in the setting step S4 are transmitted to each cargo handling apparatus 6 and each supplying apparatus 11 from the management system 10 in the notifying step S5.

The management system 10 can set the supply operation R in a spare time of an operation schedule. As one of operation items of a cargo handling apparatus 6, the supply operation R can be set in advance. Since a schedule of supplying the fuel can be set before the cargo handling apparatus 6 runs out of the fuel, it can also be said that the supply operation R is controlled in a feedforward manner. Since a situation in which a cargo handling apparatus 6 runs out of the fuel and becomes inoperable can be avoided, this is advantageous in suppressing a decrease in cargo handling efficiency.

In the case where the supplying apparatus 11 is of mobile type, the moving of the supplying apparatus 11a or the preparation for conducting a supply operation R can be conducted while the cargo handling apparatus 6 is conducting a cargo handling operation. In addition, in the case where the fuel reserved in the terminal 1 is insufficient, the order of the fuel to the outside of the terminal 1 and the like can be conducted in advance. This is advantageous in suppressing a decrease in cargo handling efficiency.

As illustrated in FIG. 8, a configuration may be employed in which the setting step S4 acquires the necessary time P3 from the estimating step S6 and sets an initiation time t for the supply operation R from this necessary time P3 and the current time. For example, in the case where a currently conducted operation item name is B3, the current time is 10:14, and an integrated value of the necessary time P3 until the supply operation R2 is 6 minutes, the setting step S4 sets the initiation time t for the supply operation R2 to 10:20.

The setting step S4 can add time t to the operation schedule. Since the initiation time t for the supply operation R is set, the mobile supplying apparatus 11a can be moved to stand by in advance to a location where the gantry crane 6b is to be supplied with the fuel, for example. In the case where the mobile supplying apparatus 11a is driven by a worker, a configuration may be employed in which the management system 10 notifies the supplying apparatus 11a of the initiation time t. The mobile supplying apparatus 11a includes a device such as a communication device for receiving the notification sent from the management system 10.

A configuration may be employed in which the setting step S4 adds initiation time t to each piece of cargo handling operation data in addition to the initiation time t of the supply operation R. There is a case where time t at which a cargo handling operation can be started after the container ship 4 births at the quay 5 is determined in advance. The setting step S4 may have a configuration of setting initiation time t of a certain cargo handling operation data based on this time t. As illustrated in FIG. 8, in the case where data group C is ship cargo handling, and time t at which cargo handling with the container ship 4 can be started is 11:00, it is obvious that the operation of C1 will start at least after 11:00. The initiation time t of C1 is set at 11:00, for example.

A configuration may be employed in which initiation times t of the supply operation R and each piece of cargo handling operation data are corrected in the setting step S4 every time an item of the cargo handling operation data is executed and completed. In this case, the setting step S4 and the estimating step S6 are repeatedly executed. It becomes easier to maintain the accuracy of initiation times t even in the case where time required for an operation is shifted from an estimated necessary time P3, or there has been a delay in an operation. As items of the cargo handling operation data are executed, and an item of the supply operation R2 comes closer, for example, the accuracy of the initiation time t for the supply operation R2 can be improved more.

A configuration may be employed in which in the setting step S4, a supply operation R is inserted into a spare time between data groups. In this case, a supply operation R is inserted into a spare time between A3 and B1 or between B5 and C1 of operation item names in FIG. 8. No supply operation R is inserted into a spare time between B2 and B3.

In the case where it is necessary to conduct a series of continuous cargo handling operations such as ship cargo handling in a short period of time, since no supply operation R is conducted in a middle thereof, this is advantageous in improving the cargo handling efficiency. Even if a failure or the like has occurred during a supply operation R to prevent the operation from being completed in time, since this is not in a middle of a series of cargo handling operations, an influence on the cargo handling operation can be suppressed.

As illustrated in FIG. 6, the management system 10 may have a configuration of executing a computing step S7 of calculating a supply amount P4 [kg] which is an amount of the hydrogen gas to be supplied in a supply operation R. The computing step S7 is not an essential configuration requirement. A configuration may be employed in which a lower limit value is set when a supply amount P4 is calculated in the computing step S7. In this event, the computing step S7 acquires a necessary amount P1 until the end of the data group after the supply operation R from the estimating step S6. The computing step S7 calculates the supply amount P4 using an amount of the hydrogen gas which is a difference between the necessary amount P1 and the remaining amount P2 as the lower limit value. The supply amount P4 thus calculated is associated with the operation schedule as data. A configuration may be employed in which when receiving notification on a supply operation R from the management system 10, the supplying apparatus 11 receives information of a supply amount P4 together with an initiation time t for the supply operation R, for example.

A specific example will be described below. In the case where the supply operation R2 is conducted between the operation item names B5 and C1 illustrated in FIG. 8, the computing step S7 acquires a necessary amount P1 until the end of the data group C from the estimating step S6. In the case of a time point at which the operation of the operation item name B3 has been completed, the computing step S7 acquires a current remaining amount P2 and a necessary amount P1 in B4-5 (0.7 kg) and C1-16 (8.0 kg). In the case where the current remaining amount P2 is 2.0 kg and the necessary amount P1 is 0.7+8.0=8.7 kg, for example, the difference therebetween, 6.7 kg is calculated as the lower limit value for a supply amount P4 in the computing step S7. In the supply operation R2, the fuel of 6.7 kg or more is supplied to the cargo handling apparatus 6.

In the computing step S7, the supply amount P4 is set to, for example, 6.7 kg, which is the lower limit value. The supply amount P4 may be set to an amount obtained by adding an amount set in advance such as, for example, 1.0 kg to the lower limit value. The supply amount P4 in this case is 6.7+1.0=7.7 kg. The supply amount P4 may be set to an amount obtained by multiplying the lower limit value by a multiplying factor set in advance such as, for example, 120%. The supply amount P4 in this case is 6.7×1.20=8.04 kg.

The configuration of setting the lower limit value in the computing step S7 makes it possible to avoid a situation in which the cargo handling apparatus 6 runs out of the fuel and becomes inoperable during the operations of the data group C which will follow the supply operation R2. This is advantageous in suppressing a decrease in cargo handling efficiency.

A configuration may be employed in which an upper limit value is set when the supply amount P4 is calculated in the computing step S7. In this case, the computing step S7 acquires, from the operation schedule, initiation time t of a data group after the supply operation R. The supply amount P4 is calculated in the computing step S7 with the amount of the hydrogen gas which can be supplied to the cargo handling apparatus 6 by this initiation time t as the upper limit value. The supply amount P4 thus calculated is associated with the operation schedule as data.

A specific example will be described below. In the case where the supply operation R2 is conducted between the operation item names B5 and C1 illustrated in FIG. 8, the computing step S7 acquires, from the operation schedule, initiation time t such as 11:00, for example, in the data group C. If the supply operation R2 is completed by this initiation time t, 11:00, the cargo handling operations in the data group C are started without delay. In the case where the initiation time t for the supply operation R2 is set to, for example, 10:20 in the operation schedule, this makes it possible to conduct the supply operation R2 for 40 minutes.

In the creating step S3, the same method as that in the above-described computing step S7 may be utilized in setting a spare time during which no cargo handling operation is executed between a plurality of cargo handling operation times. That is, in the case where there is data for which the initiation time t has been set in advance among cargo handling operation data, a spare time can be set to time before the initiation time t.

The supply operation R also includes an operation of coupling the supplying apparatus 11 and the cargo handling apparatus 6 with a pipe for the hydrogen gas, and the like. The time in which the hydrogen gas can be supplied becomes shorter than the time for the supply operation R1, and is, for example, 35 minutes. Hence, the amount of the hydrogen gas which can be supplied in this time, for example, 59.5 kg becomes the upper limit value for the supply amount P4. The amount of the fuel equal to or less than 59.5 kg is supplied to the cargo handling apparatus 6 in the supply operation R2.

In the computing step S7, the supply amount P4 is set to be 59.5 kg of the upper limit value, for example. The supply amount P4 may be set to an amount obtained by subtracting an amount set in advance such as, for example, 5.0 kg from the upper limit value. The supply amount P4 in this case is 59.5−5.0=54.5 kg. The supply amount P4 may be set to an amount obtained by multiplying the upper limit value by a multiplying factor set in advance such as, for example, 90%. The supply amount P4 in this case is 59.5×0.9=53.55 kg.

In the case where initiation time t for a data group after the supply operation R2 is not set, the upper limit value for the supply amount P4 may be set to an amount that can fill up the hydrogen tank of the cargo handling apparatus 6. In the case where the capacity of the hydrogen tank of the gantry crane 6b is, for example, 100 kg, it takes about 1 hour to fill up the hydrogen tank from the state where the remaining amount P2 is substantially zero, for example.

The configuration of setting the upper limit value in the computing step S7 makes it possible to supply the fuel to the cargo handling apparatus 6 in time for the initiation time t for the data group C which will follow the supply operation R2. This is advantageous in suppressing a decrease in cargo handling efficiency.

In the case where the supplying apparatus 11 conducts supply operations R for a plurality of cargo handling apparatuses 6, the supply amount P4 may be calculated in the computing step S7 using the amount of the hydrogen gas which the supplying apparatus 11 can supply in time for the next supply operation R as the upper limit value. This is advantageous in improving the operating rate of the supplying apparatus 11.

The computing step S7 may have a configuration of calculating a maximum value of the amount of the hydrogen gas which can be supplied to a cargo handling apparatus 6 from a difference between the pressure of a hydrogen tank mounted on the cargo handling apparatus 6 and the pressure of a hydrogen tank mounted on the supplying apparatus 11. In this case, in the computing step S7, the maximum value of the amount of the hydrogen gas which is calculated based on the aforementioned difference in pressure and the maximum value of the amount of the hydrogen gas which can be supplied from the supplying apparatus 11 to the cargo handling apparatus 6 during a spare time in which the supply operation R is set. The maximum value of the amount of the hydrogen gas based on the difference in pressure and the maximum value of the amount of the hydrogen gas based on the spare time are compared, and a smaller maximum value is set as the upper limit value in the computing step S7.

This configuration makes it possible to avoid a failure in which the supply amount P4 set by utilizing a spare time actually cannot be supplied to the cargo handling apparatus 6 in the case of filling the cargo handling apparatus 6 with the hydrogen gas using a difference in pressure. The configuration utilizing a difference in pressure in calculating the supply amount P4 in the computing step S7 is not an essential configuration requirement. For example, in the case where the supplying apparatus 11 includes a compressor and the hydrogen gas is supplied with pressure to the cargo handling apparatus 6, the supply amount P4 set by utilizing only a spare time can be supplied to the cargo handling apparatus 6.

A configuration may be employed in which in the computing step S7, both of the lower limit value and the upper limit value are set, and the supply amount P4 is calculated based on these. In this case, the supply amount P4 may be set to an amount indicated in the example of the upper limit value, for example. According to the aforementioned example, the supply amount P4 is set to 59.5 kg. The supply amount P4 may be set to an amount equal to an average value of the upper limit value and the lower limit value. According to the aforementioned example, the supply amount P4 is set to (6.7+59.5)/2=33.1 kg. Since the time for the supply operation R can be made shorter by setting the supply amount P4 to an amount equal to an average value of the upper limit value and the lower limit value than to the upper limit value, the supplying apparatus 11a can conduct the supply operation R for another gantry crane 6b.

For example, there can be a case where the lower limit value exceeds the upper limit value such as a case where the time for which the supply operation R2 can be conducted is short relative to the amount of the hydrogen gas necessary for executing the data group C following the supply operation R2. It becomes difficult to proceed with the operation schedule. The management system 10 may have a configuration of transmitting notification to request a significant change of the operation schedule in such a case. The worker of the management building 7 conduct a countermeasure of changing a storage lane 3 on which to store the container 2 and conducting cargo handling with a different cargo handling apparatus 6, or the like. The operation of changing a storage lane 3 and the like may be achieved by executing the allocating step S2 again.

On the other hand, it becomes easier to avoid a case where the lower limit value exceeds the upper limit value by setting a wider range for creating an operation schedule such as by after 24 hours, for example.

As illustrated in FIG. 6, the estimating step S6 may have a configuration of estimating a necessary time P3 which is necessary for a supply operation R based on a supply amount P4 calculated in the computing step S7. In this case, a configuration may be employed in which in the setting step S4, a termination time t of the supply operation R is set from the aforementioned necessary time P3 and the current time.

Since the termination time t of the supply operation R is set, it becomes possible to set an operation schedule of the next supply operation R for another supplying apparatus 11. Since initiation times t and termination times t of supply operations R for a plurality of cargo handling apparatuses 6 can be set in advance, this is advantageous in improving the operating rate of the supplying apparatus 11.

Specifically, the supply operation R for the second cargo handling apparatus 6 can be set in the operation schedule at time after the termination time t of the supply operation R for the first cargo handling apparatus 6. The number of the supplying apparatuses 11 is not limited to one. The terminal 1 may include a plurality of supplying apparatuses 11. It is desirable that the number of spare times overlapping in the same time be based on the number of the supplying apparatuses 11 in an operation schedule of each cargo handling apparatus 6. This makes it possible to avoid a failure in which although supply operations R have been set in spare times of a plurality of cargo handling apparatuses 6, the number of the supplying apparatuses 11 is insufficient, so that the supply operations cannot be executed as set in operation schedules.

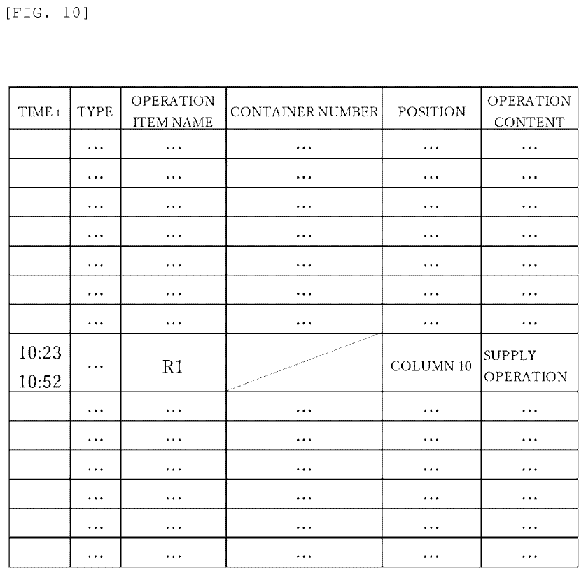

Examples of operation schedules set in a plurality of cargo handling apparatuses 6 are shown in FIGS. 9 and 10. In the case where the gantry crane 6b is a manned crane operated by an operator, the operator conducts the cargo handling operations while checking this operation schedule. As illustrated in FIG. 9 and FIG. 10, in the operation schedules, the initiation times and the termination times of supply operations R are set, and columns which are positions at which the supply operations R are to be conducted are set. It is desirable that the columns be set, for example, at positions at which the immediately preceding operation items are completed in order to avoid a situation in which the gantry crane 6b moves along with the supply operation R.

In the plurality of cargo handling apparatuses 6, priority of each supply operation R is set. The priorities may be set, for example, such that the cargo handling apparatus 6 which conducts ship cargo handling has higher priority, and the priority becomes lower in order of external cargo handling and rearrangement cargo handling. The management system 10 sets a supply operation R from a cargo handling apparatus 6 having high priority. In the case where the supplying apparatus 11 is of mobile type, indexes for increasing the efficiency of a travel route of the supplying apparatus 11a may be reflected in the aforementioned priorities. This makes it possible to preferentially conduct the supply operation R on a cargo handling apparatus 6 having high priority while achieving a situation in which the travel route of the supplying apparatus 11a becomes shortest.

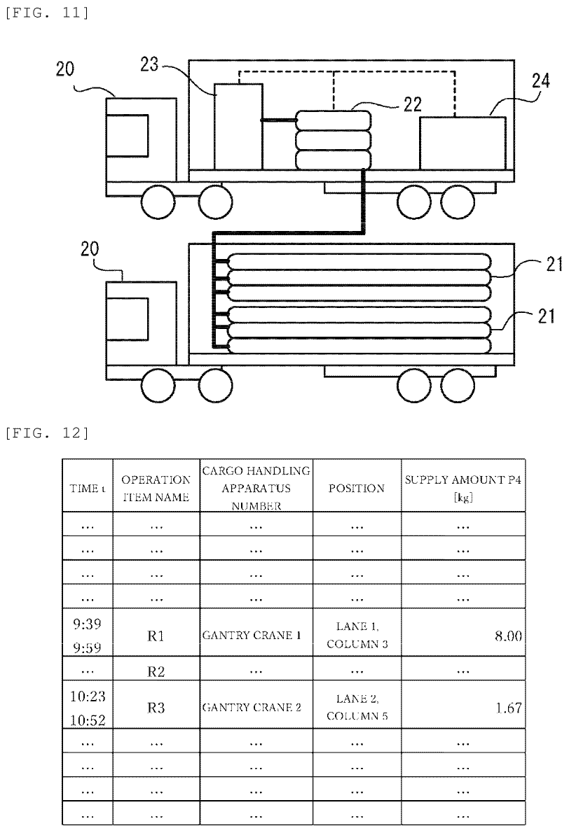

As illustrated in FIG. 11, the mobile supplying apparatus 11a may include a vehicle 20 and hydrogen tanks 21 mounted on this vehicle 20. In this embodiment, the supplying apparatus 11a is configured with two vehicles 20. The first vehicle 20 includes a plurality of hydrogen tanks 21 disposed in a 20-ft container. These hydrogen tanks 21 are filled with the hydrogen gas compressed to high pressure such as 82 MPa, for example. On the vehicle 20, 16 hydrogen tanks 21 each filled with 12.5 kg of the hydrogen gas are mounted, for example.

The second vehicle 20 includes a precooler 22 which cools the hydrogen gas supplied from the hydrogen tanks 21, a dispenser 23 which supplies the hydrogen gas cooled by the precooler 22 to a cargo handling apparatus 6, and a rechargeable battery 24 which supplies electricity to the precooler 22 and the dispenser 23. The precooler 22 and the like may be disposed in a 20-ft container mounted on the vehicle 20. In FIG. 11, pipes for feeding the hydrogen gas are indicated by thick lines, and power supply cables connected to the rechargeable battery 24 are indicated by dashed lines for explanation.

The supplying apparatus 11a configured with the two vehicles 20 moves to near a gantry crane 6b before the initiation time t of a supply operation R in accordance with information sent from the management system 10. The two vehicles 20 may be configured with manned vehicles driven by workers, or may be configured with unmanned vehicles driven by automatic control.

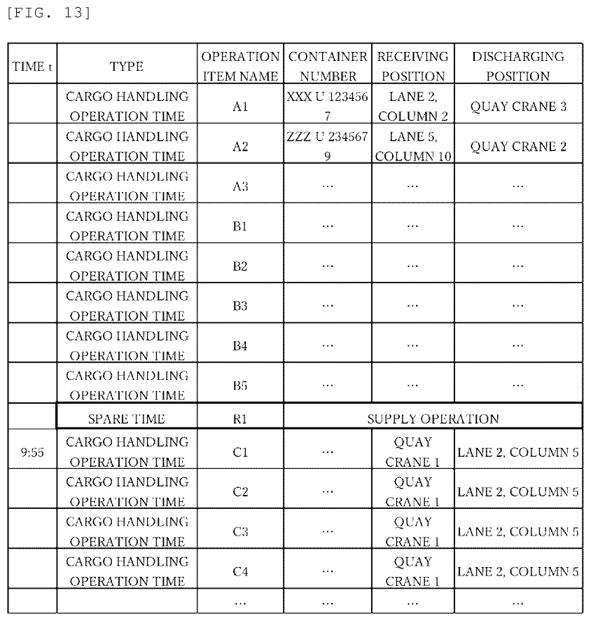

An example of an operation schedule which the supplying apparatus 11a is notified of is shown in FIG. 12. In the case where the vehicles 20 are manned vehicles driven by workers, the workers conduct a supply operation R while checking this operation schedule. In the operation schedule, cargo handling apparatus number to be supplied, and initiation time and termination time in each supply operation R are set, and a position to conduct the supply operation R and a supply amount P4 are set. The management system 10 notifies the supplying apparatus 11a to move to the position to conduct the supply operation before the initiation time of the supply operation R. As the position to conduct the supply operation R, the number of a storage lane and column are set. The supplying apparatus 11a moves to the designated position by the initiation time of the supply operation R.

As illustrated in FIG. 11, when the supply operation R is started, the workers couple the hydrogen tanks 21 and the precooler 22 with pipes, and couple the dispenser 23 and the cargo handling apparatus 6 with pipes. The cargo handling apparatus 6 is filled with the hydrogen gas from hydrogen tank 21 with a difference in pressure. When the supply operation R is ended, the workers release the coupling of the pipes coupled to the precooler 22 and the cargo handling apparatus 6.

Since the vehicles 20 of the mobile supplying apparatus 11a can more easily move than the gantry crane 6b, the vehicles 20 can move to near the gantry crane 6b and conduct the supply operation R. The supply operation R can be conducted in a middle portion of the storage lane 3 in the extension direction. Since the vehicles 20 which have higher travel speed than the gantry cranes 6b move, this is advantageous in efficiently conducting the supply operation R.

Since this embodiment is configured such that the supplying apparatus 11a supplies the hydrogen gas to the cargo handling apparatus 6 with a difference in pressure, a compressor is unnecessary. Since a power supply for a compressor is unnecessary, it becomes possible to conduct the supply operation R in a desired location. A compressor requires a power supply of 110 kw, for example, and needs to be connected to a power supply cable of 450 V. In the case where the supplying apparatus 11a includes a compressor, the supply operation can be conducted only in a location where there is a power supply cable of 450 V. Note that the precooler 22 and the dispenser 23 can be operated with a power supply of about 10 kw, and can be operated with power supplied from the rechargeable battery 24 mounted on the vehicle 20.

Since the supplying apparatus 11a is configured with the two vehicles 20, in the case where the remaining amount of the hydrogen tank 21 has run short, the supply operation R can be continued by bringing another vehicle 20 on which the hydrogen tanks 21 are mounted. The supply operation R can be efficiently conducted by preparing a plurality of vehicles 20 on which the hydrogen tanks 21 are mounted for one vehicle 20 on which the dispenser 23 and the like are mounted. This is advantageous in improving the operating rate of the supplying apparatus 11a.

The number of the vehicles 20 with which the supplying apparatus 11a is configured is not limited two. The supplying apparatus 11a may be configured with one vehicle 20. A 40-ft container may be mounted on this vehicle 20, in which devices such as the dispenser 23 and the like and the hydrogen tanks 21 are disposed inside this 40-ft container.

As illustrated in FIG. 1, the terminal 1 may include a supply lane 25 on which the vehicles 20 of the supplying apparatus 11a travel. The supply lane 25 is formed along the storage lane 3 on the side thereof. Between the supply lane 25 and the storage lane 3, a cargo handling lane 26 on which the yard chassis 6c and the external chassis 8 travel are formed. The vehicles 20, the yard chassis 6c, and the like travel on dedicated lanes. The vehicles 20 which are conducting the supply operation R do not interrupt the travel of the yard chassis 6c and the like. This is advantageous in suppressing a decrease in cargo handling efficiency. The terminal 1 does not have to include a supply lane 25 such that the vehicles 20 with which the supplying apparatus 11a is configured travel on the cargo handling lane 26 to approach the gantry crane 6b.

As illustrated in FIG. 1, the terminal 1 may include an operation area 27 where to conduct the supply operation R. The operation area 27 is formed in an end portion of the storage lane 3 in the extension direction (the left-right direction in FIG. 1). In this case, the operation area 27 is formed for each storage lane 3. When the supply operation R is conducted, the gantry crane 6b and the vehicles 20 of the supplying apparatus 11a move to the operation area 27. Since the location to conduct the supply operation R is confined, it becomes possible to prepare a power supply cable of 450 V, for example. It becomes possible to configure the supplying apparatus 11a with a vehicle 20 including a compressor.

The supply operation R is conducted at an end portion of the storage lane 3. Even in the case where a plurality of gantry cranes 6b conduct cargo handling operations in one storage lane 3, one gantry crane 6b during the supply operation R does not interrupt the cargo handling operation of another gantry crane 6b. In addition, the supplying apparatus 11a during the supply operation R does not interrupt the travel of the yard chassis 6c and the like. This is advantageous in suppressing a decrease in cargo handling efficiency in the terminal 1.

In the case where the cargo handling apparatus 6 is a yard chassis 6c as illustrated in FIG. 13 as well, an operation schedule is set by the management system 10 as in the case of the gantry crane 6b. The container number of a container 2 to be handled, a receiving position at which the container 2 is received, and a discharging position at which the container 2 is discharged are set. In the estimating step S6, the necessary amount P1 is estimated from the travel distance of the yard chassis 6c. The estimating step S6 may have a configuration of estimating a workload from the weight of the container 2 to be handled and estimating the necessary amount P1 from this workload, in addition to the travel distance of the yard chassis 6c. In the setting step S4, a supply operation R is set in at least one of a plurality of spare times. In the case where the management system 10 has a configuration of executing the estimating step S6, the supply operation R is set in the operation schedule based on the remaining amount P2 of the hydrogen tank in the yard chassis 6c and the necessary amount P1. This supply operation R is set in a spare time.

The yard chassis 6c travels to the stationary supplying apparatus 11b and is supplied with the hydrogen gas in accordance with an instruction of the supply operation R in the operation schedule. In the case where the management system 10 has a configuration of executing the computing step S7, the yard chassis 6c is supplied with the hydrogen gas in an amount corresponding to the supply amount P4 set in the computing step S7. A sensor which identifies the yard chassis 6c may be disposed near the dispenser of the supplying apparatus 11b. The yard chassis 6c is supplied with the hydrogen gas based on the supply amount P4 corresponding to the identification number of the yard chassis 6c. A configuration may be employed in which the identification number is inputted into the dispenser by the worker, and the supply amount P4 set in advance is supplied to the yard chassis 6c.

For the stationary supplying apparatus 11b, an operation schedule may be set. In this operation schedule, for example, the identification number of the yard chassis 6c, the supply amount P4, the initiation time and the termination time of the supply operation R, and the like can be set. The stationary supplying apparatus 11b includes a communication device or the like for receiving a schedule and a supply amount P4 transmitted from the management system 10.

This is advantageous in avoiding a failure in which the yard chassis 6c runs out of the fuel during the cargo handling operation. In addition, the time at which each yard chassis 6c receives the supply operation R from the supplying apparatus 11b and the supply amount P4 can be adjusted by the operation schedule. It is possible to avoid such a situation that a plurality of yard chassis 6c are waiting for supply operations R near the supplying apparatus 11b. This is advantageous in improving the operation efficiency of the yard chassis 6c.

In the case where the external chassis 8 uses a hydrogen gas as the fuel, the cargo handling apparatus 6 may include the external chassis 8. The external chassis 8 is configured with a manned chassis or an unmanned chassis. It is desirable that the external chassis 8 include a device and the like similar to the yard chassis 6c. Specifically, it is desirable that the external chassis 8 include a device such as a communication device for receiving an operation schedule sent from the management system 10 and transmitting the remaining amount P2 of the mounted hydrogen tank to the management system 10. Like the yard chassis 6c, the external chassis 8 can travel to the stationary supplying apparatus 11b and be supplied with the hydrogen gas in accordance with an instruction of the supply operation R in the operation schedule.

There is a case even when the external chassis 8 does not include a device or the like similar to the yard chassis 6c, the cargo handling apparatus 6 includes such a device. When an external chassis 8 is received at the gate 9 of the terminal 1, the identification number of the external chassis 8, the container number to be handled by the external chassis 8, and the like are recorded in the management system 10. In this event, the remaining amount P2 of the hydrogen tank of the external chassis 8 may be recorded in the management system 10. The external chassis 8 receives an operation schedule and the like, which are set by the management system 10, at the gate 9. The external chassis 8 can be supplied with the hydrogen gas in accordance with an instruction of the supply operation R in the operation schedule. Even in the case where the external chassis 8 does not include a communication device or the like for communicating data with the management system 10, the external chassis 8 can receive an operation schedule and the like at the gate 9. This makes it possible for the terminal 1 to incorporate the external chassis 8 as a cargo handling apparatus 6 into control.

In the case where the cargo handling apparatus 6 and the supplying apparatus 11 are controlled by workers, the workers conduct the operation while referring to an operation schedule. In the case where the cargo handling apparatus 6 and the like are automatically controlled by a control apparatus, the control apparatus controls the cargo handling apparatus 6 and the like based on operation schedules.

The supply operation R for the cargo handling apparatuses 6 using the hydrogen gas as the fuel has been described so far. The management system 10 of the present invention can be utilized even in the case of supplying light oil to a cargo handling apparatus and in the case of charging a rechargeable battery of a cargo handling apparatus with a supplying apparatus. A cargo handling apparatus using light oil as a fuel can be supplied with the light oil even when the size of a fuel tank is reduced, without lowering a cargo handling efficiency.

Even in the case where the supplying apparatus charges a cargo handling apparatus, there is a possibility that the number of times of charge increases as in the case where the hydrogen gas is used as the fuel. Even in such a case, since the cargo handling apparatus can be efficiently charged, a decrease in cargo handling efficiency can be suppressed.

The cargo handling apparatus 6 may be configured to include a rechargeable battery such as lithium-ion battery, for example, such that the supplying apparatus 11 supplies electricity as the fuel. In this case, the cargo handling apparatuses 6 and the supplying apparatuses 11 include rechargeable batteries in place of the hydrogen tanks. In the present Description, the fuel is a concept encompassing electricity.

In the case where the fuel is electricity, the amount of electricity [kWh] is used as the necessary amount P1, the remaining amount P2, and the supply amount P4. In the estimating step S6, a necessary amount P1 [kWh] which is the amount of electricity to be consumed in a certain cargo handling operation is estimated. The remaining amount sensor 18 measures a remaining amount P2 [kWh] of electricity in a rechargeable battery mounted on the cargo handling apparatus 6. In the computing step S7, a supply amount P4 [kWh] which is the amount of electricity to be supplied in the supply operation R is calculated.

The fuel may be methylcyclohexane obtained by chemically reacting hydrogen and toluene. In this case, the cargo handling apparatus 6 includes a hydrogen engine using hydrogen as the fuel and a fuel cell, for example. Methylcyclohexane is dehydrogenated via a catalyst in a temperature environment of about 300° C. to be separated into hydrogen and toluene. In this embodiment, the cargo handling apparatus 6 includes a hydrogen engine, a dehydrogenation apparatus which separates hydrogen from methylcyclohexane, a tank which reserves methylcyclohexane, and a tank which recovers toluene separated. The dehydrogenation apparatus conducts separation of hydrogen by utilizing heat, for example, of 300° C. or more which is discharged from the hydrogen engine. The supplying apparatus 11 has a configuration of supplying methylcyclohexane to the cargo handling apparatus 6 and recovering toluene in the supply operation R. Since exhaust heat of the hydrogen engine is utilized as a heat source for dehydrogenating methylcyclohexane, hydrogen separated from methylcyclohexane can be efficiently utilized as power of the cargo handling apparatus 6.

When the management system 10 creates an operation schedule, it is assumed that the constraint condition that cargo handling efficiency from initiation to termination of cargo handling operations indicated by the large number of pieces of cargo handling operation data does not fall below the reference is satisfied. However, the case where the operation schedule does not satisfy the aforementioned constraint condition is also encompassed by the present invention. For example, an operation schedule used in an existing terminal may be diverted. In some terminals, workers create operation schedules based on experimental rules. In addition, some terminals include existing systems for creating operation schedules based on certain rules. The management system 10 may have a configuration of setting a spare time between cargo handling operation times in an original operation schedule prepared in advance for each cargo handling apparatus 6 and creating a new operation schedule incorporating the cargo handling operation times and the spare time. In this event, in the management system 10, the original operation schedule prepared in advance is inputted, and a new operation schedule incorporating cargo handling operation times and a spare time is outputted.

The present invention is not limited to the configuration in which the supply operation R for supplying the fuel from the supplying apparatus 11 to the cargo handling apparatus 6 is set in at least one of a plurality of spare times. A maintenance operation or at least one of replacement and break for drivers of the cargo handling apparatus 6 may be set in a spare time instead of a supply operation R.

It can also be said that the management system 10 of the present invention has the following characteristics. The management system 10 is a management system 10 which allocates a plurality of pieces of cargo handling operation data among a large number of pieces of cargo handling operation data to each of a plurality of cargo handling apparatuses 6, characterized in that the management system 10 executes data processing of creating an operation schedule for each of the plurality of cargo handling apparatuses 6, the operation schedule incorporating a plurality of cargo handling operation times during which the cargo handling operations indicated by the allocated plurality of pieces of cargo handling operation data are conducted and a spare time during which no cargo handling operation is conducted between the plurality of cargo handling operation times.

The management system 10 may have a configuration of acquiring position information and a remaining amount P2 of a cargo handling apparatus 6 at a certain time interval, or may have a configuration of acquiring position information and the like in real time. For example, the management system 10 can acquire position information and the like of the cargo handling apparatus 6 and the like at a time interval set within a range of 1 second to 60 seconds in advance.

The management system 10 may have a configuration of acquiring position information of the cargo handling apparatus 6. Specifically, for example, a configuration may be employed in which a plurality of cargo handling apparatuses 6 each include an antenna of a global navigation satellite system (GNSS). Position information of the cargo handling apparatus 6 is acquired by this antenna of GNSS and sent to the management system 10. The configuration in which the management system 10 acquires position information of the cargo handling apparatus 6 is not limited to the above-described configuration. A configuration may be employed in which a relative position between a transponder installed in the terminal 1 and the cargo handling apparatus 6 is detected, and the management system 10 acquires position information. The management system 10 may have a configuration of acquiring position information of the mobile supplying apparatus 11a in the same manner as for the cargo handling apparatus 6. Here, the position information of the cargo handling apparatus 6 or the supplying apparatus 11a may be current position information acquired from the antenna of GNSS, or may be future position information estimated from the position of the container 2 designated in an operation schedule, the traveling direction of the cargo handling apparatus 6, or the like.

By the configuration of acquiring position information of the cargo handling apparatus 6, the management system 10 can find whether or not the cargo handling apparatus 6 is moving in accordance with the operation schedule. In the case where the cargo handling apparatus 6 is not moving in accordance with the operation schedule, it becomes possible to conduct a countermeasure such as change of the operation schedule. In addition, the management system 10 can find whether or not the spare time incorporated in the operation schedule will occur in accordance with the schedule. Since the management system 10 can find the states of the plurality of cargo handling apparatuses 6, this is advantageous in suppressing a decrease in cargo handling efficiency.

The management system 10 may have a configuration of acquiring a remaining amount P2 of the fuel of each cargo handling apparatus 6, and a configuration of setting a supply operation R for supplying the fuel from the supplying apparatus 11 to the cargo handling apparatus 6 in at least one of a plurality of the spare times, based on the position information and the remaining amount P2 of the cargo handling apparatus 6, and the spare time set in the operation schedule. The management system 10 can find whether or not the cargo handling apparatus 6 can complete the movement to the stationary supplying apparatus 11 by the time at which the supply operation R has been set. In addition, the management system 10 can find whether or not the cargo handling apparatus 6 and the supplying apparatus 11a can meet by the time at which the supply operation R has been set, from the position information of the cargo handling apparatus 6 and the mobile supplying apparatus 11a. Since the management system 10 can find whether or not the supply operation R can be executed as planned, it also becomes possible to change the operation schedule as necessary. It becomes possible to conduct supply of the fuel to cargo handling apparatus 6 and the like at an appropriate timing in accordance with the position information and the remaining amount P2 of the fuel of the cargo handling apparatus 6. In this event, the operation set in the spare time does not have to be the supply operation R but may be a maintenance operation or the like.

The management system 10 may have a configuration of setting a position at which to conduct the supply operation R when setting the supply operation R in the spare time. It becomes possible to set the position at which to conduct the supply operation R as appropriate based on the position information and the remaining amount P2 of the cargo handling apparatus 6. This is advantageous in suppressing a decrease in cargo handling efficiency. In this event, the operation for which to set the position does not have to be the supply operation R but may be a maintenance operation or the like.

The terminal 1 according to the present invention may have the same configurations as in the aforementioned management system 10. In this case, the terminal 1 is a terminal comprising: a plurality of cargo handling apparatuses 6; a supplying apparatus 11 which supplies a fuel to the cargo handling apparatuses 6; and a management system 10 which allocates a plurality of pieces of cargo handling operation data among a large number of pieces of cargo handling operation data to each of the cargo handling apparatuses 6, characterized in that the management system 10 executes data processing of creating an operation schedule for each of the plurality of cargo handling apparatuses 6, the operation schedule incorporating a plurality of cargo handling operation times during which cargo handling operations indicated by the allocated plurality of pieces of cargo handling operation data are executed and a spare time during which no cargo handling operation is executed between the plurality of cargo handling operation times. The management system 10 of this terminal 1 may have a configuration of acquiring position information of each cargo handling apparatus 6. The management system 10 of the terminal 1 may have a configuration of acquiring a remaining amount P2 of the fuel of each cargo handling apparatus 6, and a configuration of setting a supply operation R for supplying the fuel from the supplying apparatus 11 to the cargo handling apparatus 6 in at least one of a plurality of the spare times, based on the position information, the remaining amount P2, and the spare times. The management system 10 of the terminal 1 may have a configuration of setting a position at which to conduct the supply operation R when setting the supply operation R in the spare time.

The management method according to the present invention may have the same configurations as in the aforementioned management system 10. In this case, the management method is a management method which allocates a plurality of pieces of cargo handling operation data among a large number of pieces of cargo handling operation data to each of a plurality of cargo handling apparatuses 6, characterized in that the management method comprises executing data processing of creating an operation schedule for each of the plurality of cargo handling apparatuses 6, the operation schedule incorporating a plurality of cargo handling operation times during which cargo handling operations indicated by the allocated plurality of pieces of cargo handling operation data are executed and a spare time during which no cargo handling operation is executed between the plurality of cargo handling operation times. The management method may have a configuration of acquiring position information of each cargo handling apparatus 6. The management method may has a configuration of acquiring a remaining amount P2 of the fuel of each cargo handling apparatus 6, and a configuration of setting a supply operation R for supplying the fuel from the supplying apparatus 11 to the cargo handling apparatus 6 in at least one of a plurality of the spare times, based on the position information, the remaining amount P2, and the spare time. The management method may have a configuration of setting a position at which to conduct the supply operation R when setting the supply operation R in the spare time.

### EXPLANATION OF REFERENCE NUMERALS

1 terminal
2 container
3 storage lane
4 container ship
5 quay
6 cargo handling apparatus
6a quay crane
6b gantry crane
6c yard chassis
7 management building
8 external chassis
9 gate
10 management system
11 supplying apparatus
11a (mobile) supplying apparatus
11b (stationary) supplying apparatus
12 central processing unit
13 main storage unit
14 auxiliary storage unit
15 keyboard
16 display
17 communication device
18 remaining amount sensor
19 computation unit
20 vehicle
21 hydrogen tank
22 precooler
23 dispenser
24 rechargeable battery
25 supply lane
26 cargo handling lane
27 operation area
P1 necessary amount
P2 remaining amount
P3 necessary time
P4 supply amount
R supply operation
t time

1. A terminal comprising:
a plurality of cargo handling apparatuses which use a hydrogen gas as a fuel;
a supplying apparatus which supplies the hydrogen gas to the cargo handling apparatuses; and
a management system which allocates a plurality of pieces of cargo handling operation data among a large number of pieces of cargo handling operation data to each of the cargo handling apparatuses, characterized in that
upon satisfying a constraint condition that cargo handling efficiency from initiation to termination of cargo handling operations indicated by the large number of pieces of cargo handling operation data does not fall below a reference, the management system executes data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and
the management system has a configuration of setting a supply operation for supplying the hydrogen gas from the supplying apparatus to the cargo handling apparatus in at least one of a plurality of the spare times.

2. The terminal according to claim 1, wherein the management system estimates a necessary time which is necessary for each cargo handling operation indicated by the cargo handling operation data, and sets an initiation time of the supply operation based on the necessary time and a current time and notifies the supplying apparatus of the initiation time.

3. The terminal according to claim 2, wherein
the supplying apparatus includes a vehicle and a hydrogen tank mounted on the vehicle, and
the management system notifies the supplying apparatus to move to the cargo handling apparatus to be subjected to the supply operation before the initiation time of the supply operation.

4. A management system which allocates a plurality of pieces of cargo handling operation data among a large number of pieces of cargo handling operation data to each of a plurality of cargo handling apparatuses which use a hydrogen gas as a fuel, characterized in that
upon satisfying a constraint condition that cargo handling efficiency from initiation to termination of cargo handling operations indicated by the large number of pieces of cargo handling operation data does not fall below a reference, the management system executes data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and
the management system has a configuration of setting a supply operation for supplying the hydrogen gas from the supplying apparatus to the cargo handling apparatus in at least one of a plurality of the spare times.

5. The management system according to claim 4, wherein the management system estimates a necessary time which is necessary for each cargo handling operation indicated by the cargo handling operation data, and sets an initiation time of the supply operation based on the necessary time and a current time.

6. The management system according to claim 4, wherein the management system sets a plurality of data groups each by combining a plurality of pieces of the cargo handling operation data which are adjacent to each other when the plurality of pieces of the cargo handling operation data allocated to the cargo handling apparatus are arranged in time series, and sets the supply operation in the spare time between adjacent two of the data groups.

7. The management system according to claim 6, wherein the management system estimates a necessary amount which is an amount of the hydrogen gas necessary for a target one of the cargo handling apparatuses by an end of the data group after the supply operation, and calculates a supply amount which is an amount of the hydrogen gas to be supplied to the cargo handling apparatus in the supply operation by using, as a lower limit value, an amount of the hydrogen gas which is a difference between the necessary amount and a remaining amount of the hydrogen gas in the cargo handling apparatus.

8. The management system according to claim 6, wherein in a target one of the cargo handling apparatuses, the management system calculates a maximum value of an amount of the hydrogen gas which can be supplied to the cargo handling apparatus from a difference between a pressure of a hydrogen tank mounted on the cargo handling apparatus and a pressure of a hydrogen tank mounted on the supplying apparatus, calculates a maximum value of an amount of the hydrogen gas which can be supplied from the supplying apparatus to the cargo handling apparatus during the spare time in which the supply operation is set, and calculates a supply amount which is an amount of the hydrogen gas to be supplied to the cargo handling apparatus in the supply operation by using a smaller one of the two calculated maximum values as an upper limit value.

9. A management method which allocates a plurality of pieces of cargo handling operation data among a large number of pieces of cargo handling operation data to each of a plurality of cargo handling apparatuses which use a hydrogen gas as a fuel, characterized in that
the management method comprises upon satisfying a constraint condition that cargo handling efficiency from initiation to termination of cargo handling operations indicated by the large number of pieces of cargo handling operation data does not fall below a reference, executing data processing of creating an operation schedule for each of the plurality of cargo handling apparatuses, the operation schedule incorporating a plurality of cargo handling operation times during which the cargo handling operations indicated by the allocated plurality of pieces of cargo handling operation data are executed and a spare time during which no cargo handling operation is executed between the plurality of cargo handling operation times, and
the management method has a configuration of setting a supply operation for supplying the hydrogen gas from a supplying apparatus to the cargo handling apparatus in at least one of a plurality of the spare times.

10. A terminal comprising:
a plurality of cargo handling apparatuses;
a supplying apparatus which supplies a fuel to the cargo handling apparatuses; and
a management system which allocates a plurality of pieces of cargo handling operation data among a large number of pieces of cargo handling operation data to each of the cargo handling apparatuses, characterized in that
the management system executes data processing of creating an operation schedule for each of the plurality of cargo handling apparatuses, the operation schedule incorporating a plurality of cargo handling operation times during which cargo handling operations indicated by the allocated plurality of pieces of cargo handling operation data are executed and a spare time during which no cargo handling operation is executed between the plurality of cargo handling operation times.

11. A management system which allocates a plurality of pieces of cargo handling operation data among a large number of pieces of cargo handling operation data to each of a plurality of cargo handling apparatuses, characterized in that
the management system executes data processing of creating an operation schedule for each of the plurality of cargo handling apparatuses, the operation schedule incorporating a plurality of cargo handling operation times during which cargo handling operations indicated by the allocated plurality of pieces of cargo handling operation data are executed and a spare time during which no cargo handling operation is executed between the plurality of cargo handling operation times.

12. The management system according to claim 11, wherein the management system has a configuration of acquiring position information of each cargo handling apparatus.

13. The management system according to claim 12, wherein
the management system has
a configuration of acquiring a remaining amount of the fuel of each cargo handling apparatus, and
a configuration of setting a supply operation for supplying the fuel from the supplying apparatus to the cargo handling apparatus in at least one of a plurality of the spare times, based on the position information, the remaining amount, and the spare times.

14. The management system according to claim 13, wherein the management system has a configuration of setting a position at which to conduct the supply operation when setting the supply operation in the spare time.

15. A management method which allocates a plurality of pieces of cargo handling operation data among a large number of pieces of cargo handling operation data to each of a plurality of cargo handling apparatuses, characterized in that
the management method comprises executing data processing of creating an operation schedule for each of the plurality of cargo handling apparatuses, the operation schedule incorporating a plurality of cargo handling operation times during which cargo handling operations indicated by the allocated plurality of pieces of cargo handling operation data are executed and a spare time during which no cargo handling operation is executed between the plurality of cargo handling operation times.
